(19) United States
(12) Patent Application Publication
(10) Pub. No.: US 2008/0192600 A1
(43) Pub. Date: Aug. 14, 2008

(54) Spherical Aberration Detector

(75) Inventors: Bernardus Hendrikus Wilhelmus Hendriks, Eindhoven (NL); Sjoerd Stallinga, Eindhoven (NL); Coen Theodorus Hubertus Fransiscus Liedenbaum, Eindhoven (NL); Stein Kuiper, Eindhoven (NL); Albert Hendrik Jan Immink, Eindhoven (NL); Teunis Willem Tukker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/915,633

(22) PCT Filed: May 22, 2006
(86) PCT No.: PCT/IB2006/051625

§ 371 Date: Nov. 27, 2007

(30) Foreign Application Priority Data
Jun. 2, 2005 (EP) 05104820.5

(51) Int. Cl. G11B 5/58

(52) U.S. Cl. 369/53.17

(57) ABSTRACT

An optical scanning device (1) for scanning at least one information layer (2) of at least one optical record carrier (3). The device includes a radiation source (7) for providing at least a first radiation beam (4) comprising a first wavelength, an objective lens system (8) for converging the first radiation beam on a respective information layer (2), an information detector (23) for detecting at least a portion of the first radiation beam (22) reflected from the respective information layer, for determining information on said layer, and a spherical aberration detection system. The spherical aberration detection system includes an aberration detector (24) for detecting at least a portion of the reflected first radiation beam for determining spherical aberration of the first radiation beam, and a diffractive element (26) for diffracting at least a portion of the reflected first radiation beam towards the aberration detector (24), and for transmitting at least a portion of the reflected first radiation beam towards the information detector (23). In a first mode of operation the grating is arranged to introduce a phase change to an incident portion of a radiation beam for transmitting that portion towards the information detector (23). In a second mode of operation the grating is arranged to introduce a phase change to an incident portion of the reflected first radiation beam for diffracting that portion towards the aberration detector (24).

The present invention relates to a spherical aberration detector, to an optical scanning device incorporating such a detector, and to methods of manufacture and operation of such devices. Particular embodiments of the present invention are suitable for use in optical scanning devices compatible with two or more different formats of optical record carrier, such as compact discs (CDs), digital versatile discs (DVDs), and Blu-ray Discs (BD).

Optical record carriers exist in a variety of different formats, with each format generally being designed to be scanned by a radiation beam of a particular wavelength. For example, CDs are available, inter alia, as CD-A (CD-audio), CD-ROM (CD-read only memory) and CD-R (CD-recordable), and are designed to be scanned by means of a radiation beam having a wavelength (λ) of around 785 nm. DVDs, on the other hand, are designed to be scanned by means of a radiation beam having a wavelength of about 650 nm, and BDs are designed to be scanned by means of a radiation beam having a wavelength of about 405 nm. Generally, the shorter the wavelength, the greater the corresponding capacity of the optical disc e.g. a BD-format disc has a greater storage capacity than a DVD-format disc.

It is desirable for an optical scanning device to be compatible with different formats of optical record carriers, e.g. for scanning optical record carriers of different formats responding to radiation beams having different wavelengths whilst preferably using one objective lens system. For instance, when a new optical record carrier with higher storage capacity is introduced, it is desirable for the corresponding new optical scanning device used to read and/or write information to the new optical record carrier to be backward compatible i.e. to be able to scan optical record carriers having existing formats.

Multi-layer optical record carriers can further increase storage capacity. For example, dual layer optical record carriers comprise two information layers. Generally, the information layers are parallel, and at different depths in the optical record carrier. As each layer lies a different depth beneath the surface of the record carrier, then different amounts of spherical aberration compensation must be applied to the beams scanning different layers.

For high-NA (Numerical Aperture) systems like BD, it is desirable to actively control and correct for spherical aberration, particularly when switching between scanning different information layers on multi-layer discs. Active control requires the degree of spherical aberration to be detected, in order that appropriate spherical aberration compensation can be provided.

U.S. Pat. No. 6,229,600 describes a spherical aberration detection system, for measuring spherical aberration of an optical beam. The spherical aberration of an optical beam is determined by focusing the beam, and dividing the beam cross-section into at least two concentric zones. The sub-beams passing through the zones are each focused on a separate, respective focus detection system. The distance between the two foci is a measure of the spherical aberration present in the beam. U.S. Pat. No. 6,229,600 describes a number of different embodiments for dividing the beam into the respective zones.

It is an aim of the embodiments of the present invention to address one or more of the problems of the prior art, whether referred to herein or otherwise. It is an aim of particular embodiments of the present invention to provide an aberration detection system suitable for use in optical scanning devices compatible with two or more different formats of optical record carrier. It is an aim of particular embodiments of the present invention to provide an improved aberration detection system for use in measuring spherical aberration using a single detection system.

In a first aspect of the present invention, there is provided an optical scanning device for scanning at least one information layer of at least one optical record carrier, the device comprising: a radiation source for providing at least a first radiation beam comprising a first wavelength; an objective lens system for converging the first radiation beam on a respective information layer; an information detector for detecting at least a portion of the first radiation beam reflected from the respective information layer, for determining information on said layer; and a spherical aberration detection system comprising: an aberration detector for detecting at least a portion of the reflected first radiation beam for determining spherical aberration of the first radiation beam; and a diffractive element for diffracting at least a portion of the reflected first radiation beam towards the aberration detector, and for transmitting at least a portion of the reflected first radiation beam towards the information detector, wherein the diffractive element comprises a diffractive grating, in a first mode of operation said grating being arranged to introduce a phase change to an incident portion of a radiation beam for transmitting that portion towards the information detector, and in a second mode of operation said grating being arranged to introduce a phase change to an incident portion of the reflected first radiation beam for diffracting that portion towards the aberration detector.

Such a spherical aberration detection system allows detection of spherical aberration, with relatively little loss in optical beam power. For instance, when the radiation beam referred to in the first mode of operation is the first radiation beam, then the diffractive element acts to switch the incident portion of the beam between the aberration detector and the information detector. This allows the efficient usage of the portion of the first radiation beam incident on the diffractive grating. Alternatively, when the radiation beam referred to in respect of the first mode is another beam (i.e. not the first radiation beam), this other beam may be directed towards the information detector, without being diffracted towards the aberration detector. Thus, power is not unnecessarily wasted from this other beam by being directed towards the aberration detector.

The diffractive grating may comprise a series of steps of predetermined heights, in the first mode of operation the steps being arranged to introduce a phase change that is substantially an integral multiple of 2π to said incident portion of a radiation beam for transmitting that portion towards the information detector, and in the second mode of operation the steps being arranged to introduce a phase change that is substantially a non-integral multiple of 2π to the incident portion of the reflected first radiation beam for diffracting that portion towards the aberration detector.

The device may further comprise: a beam splitter for directing incident radiation beams received from the radiation source towards the optical record carrier, and for directing reflected radiation beams received from the optical record carrier along an optical path towards the information detector; wherein the diffractive element is positioned in the optical path between the beam splitter and the information detector.

The diffractive element may comprise a central portion for transmitting incident radiation, with the diffractive grating extending in an annulus around the central portion.

The central portion may be an aperture defined by the annulus, the aperture extending through the diffractive element.

The radiation source may be arranged for providing a second radiation beam comprising a second wavelength, the steps of the diffractive grating being arranged in said first mode of operation to introduce a phase change that is substantially an integral multiple of 2π to the portion of the second radiation beam incident on the diffractive grating, for transmitting that portion towards the information detector.

The radiation source may be arranged for providing a third radiation beam comprising a third wavelength; and wherein in a third mode of operation the steps of the diffractive grating are arranged to introduce a phase change that is substantially an integral multiple of 2π to the incident portion of the third radiation beam for transmitting that portion towards the information detector.

In the first mode of operation said steps of the diffractive grating may be arranged to introduce a phase change that is substantially an integral multiple of 2π to the incident portion of the reflected first radiation beam for transmitting that portion towards the information detector.

The information detector may comprise the aberration detector, the information detector comprising a plurality of detector elements, each arranged to detect the intensity of incident radiation.

The diffractive grating being formed in a plurality of segments, each segment comprising a respective series of said steps of predetermined height, the steps being orientated such that in said second mode of operation, the steps of each segment are arranged to introduce a phase change to diffract radiation incident upon the segment to a different detector element than the segment transmits incident radiation to when in said first mode of operation.

The diffractive element may comprise at least one fluid and a controller for altering the configuration of said fluid to switch said element between at least two modes of operation.

The fluid may comprise a birefringent material, and the controller may be arranged to alter the orientation of the preferential axis of the birefringent material adjacent to the steps of the diffractive grating.

The birefringent material may comprise a liquid crystal, and the controller may be arranged provide an electric field across the liquid crystal for altering the orientation of the liquid crystal.

The at least one fluid may comprise a first fluid having a first refractive index, and a second fluid having a second, different refractive index, the two fluids being non-miscible, the controller being arranged to control which of said fluids is adjacent the steps of the diffractive grating.

The at least one fluid may comprise a first fluid having a first refractive index, and a second fluid having a second, different refractive index, the two fluids being non-miscible, the device further comprising an electrode covering at least one of the diffractive grating and a cover plate facing the grating, for altering the effective hydrophobicity of the grating or cover plate by means of a voltage difference applied between one of the fluids and said electrode.

According to a second aspect of the present invention, there is provided a spherical aberration detection system for an optical scanning device for scanning at least one information layer of at least one optical record carrier, the device comprising: a radiation source for providing at least a first radiation beam comprising a first wavelength; an objective lens system for converging the first radiation beam on a respective information layer; and an information detector for detecting at least a portion of the first radiation beam reflected from the respective information layer, for determining information on said layer; the spherical aberration detection system comprising: an aberration detector for detecting at least a portion of the reflected first radiation beam for determining spherical aberration of the first radiation beam; and a diffractive element for diffracting at least a portion of the reflected first radiation beam towards the aberration detector, and for transmitting at least a portion of the reflected first radiation beam towards the information detector, wherein the diffractive element comprises a diffractive grating, in a first mode of operation said grating being arranged to introduce a phase change to an incident portion of a radiation beam for transmitting that portion towards the information detector, and in a second mode of operation said grating being arranged to introduce a phase change to an incident portion of the reflected first radiation beam for diffracting that portion towards the aberration detector.

According to a third aspect of the present invention, there is provided a method of manufacture of an optical scanning device for scanning at least one information layer of at least one optical record carrier, the method comprising: providing a radiation source for providing at least a first radiation beam comprising a first wavelength; providing an objective lens system for converging the first radiation beam on a respective information layer; providing an information detector for detecting at least a portion of the first radiation beam reflected from the respective information layer, for determining information on said layer; and providing a spherical aberration detection system comprising: an aberration detector for detecting at least a portion of the reflected first radiation beam, for determining spherical aberration of the first radiation beam; and a diffractive element for diffracting at least a portion of the reflected first radiation beam towards the aberration detector, and for transmitting at least a portion of the reflected first radiation beam towards the information detector, wherein the diffractive element comprises a diffractive grating, in a first mode of operation said grating being arranged to introduce a phase change to an incident portion of a radiation beam for transmitting that portion towards the information detector, and in a second mode of operation said grating being arranged to introduce a phase change to an incident portion of the reflected first radiation beam for diffracting that portion towards the aberration detector.

According to a fourth aspect of the present invention, there is provided a method of operation of an optical scanning device for scanning at least one information layer of at least one optical record carrier, the device comprising: a radiation source for providing at least a first radiation beam comprising a first wavelength; an objective lens system for converging the first radiation beam on a respective information layer; an information detector for detecting at least a portion of the first radiation beam reflected from the respective information layer, for determining information on said layer; and a spherical aberration detection system comprising: an aberration detector for detecting at least a portion of the reflected first radiation beam for determining spherical aberration of the first radiation beam; and a diffractive element for diffracting at least a portion of the reflected first radiation beam towards the aberration detector, and for transmitting at least a portion of the reflected first radiation beam towards the information detector, wherein the diffractive element comprises a diffractive grating, in a first mode of operation said grating being arranged to introduce a phase change to an incident portion of a radiation beam for transmitting that portion towards the information detector, and in a second mode of operation said grating being arranged to introduce a phase change to an incident portion of the reflected first radiation beam for diffracting that portion towards the aberration detector, the method comprising providing the first radiation beam comprising a first wavelength for scanning of an information layer of an optical record carrier.

Preferred embodiments of the present invention will now be described, by way of example only, with reference to the accompanying drawings, in which:

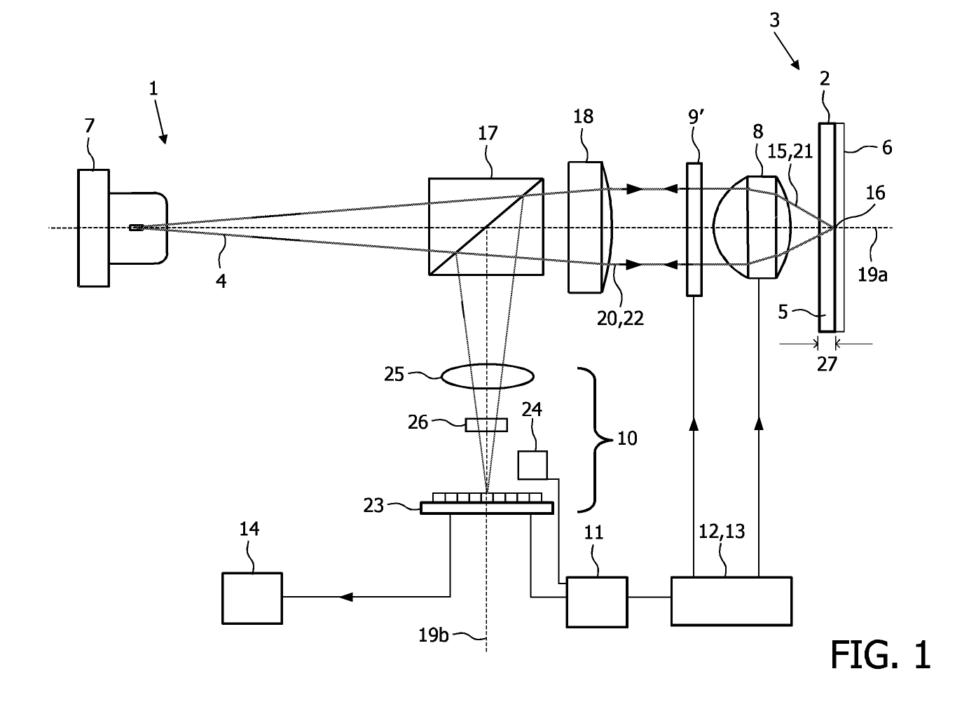

FIG. 1 is a schematic diagram of an optical scanning device according to an embodiment of the present invention;

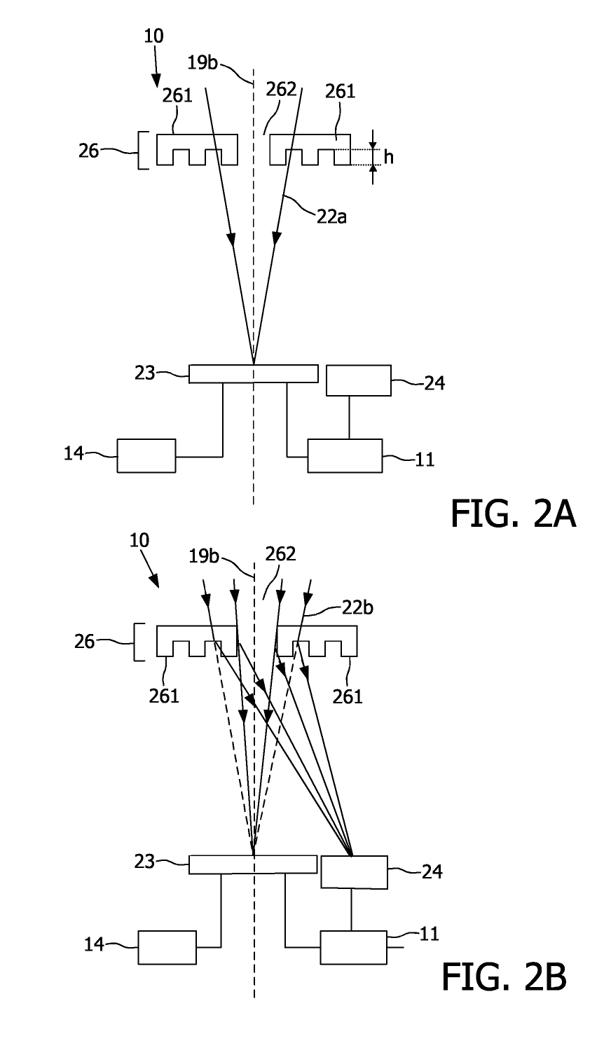

FIGS. 2A and 2B show two different modes of operation of the aberration detector illustrated in FIG. 1;

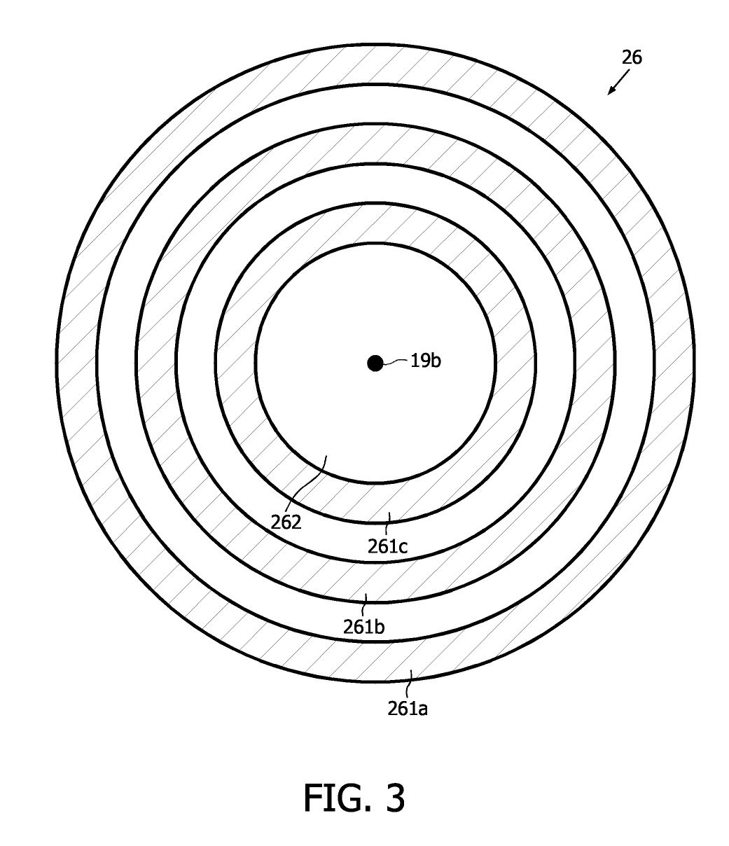

FIG. 3 shows a plan view of a diffractive element in accordance with an embodiment of the present invention;

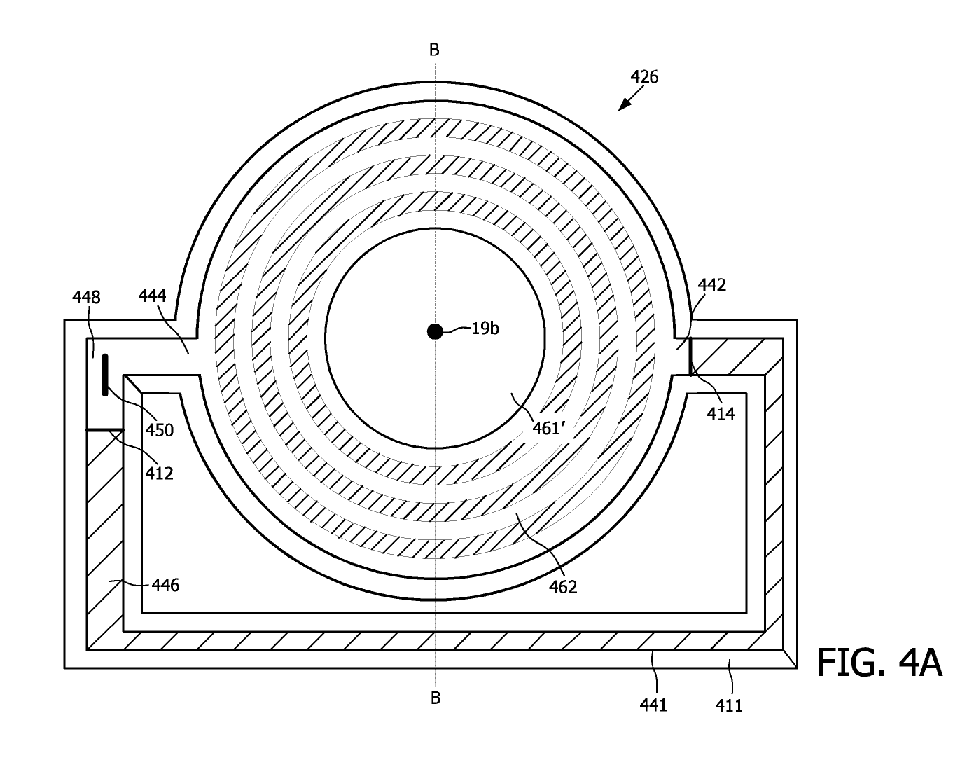

FIGS. 4A and 4B show respectively a cross-sectional plan view and a cross sectional side-view of a diffractive element in accordance with a further embodiment of the present invention;

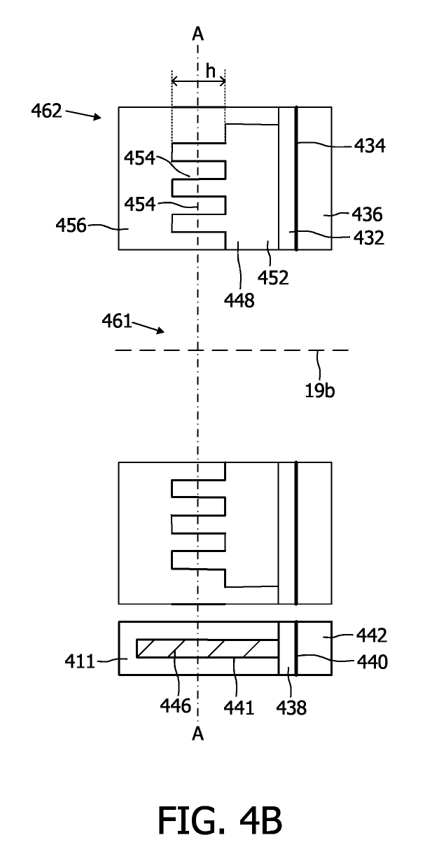

FIG. 5 is a schematic diagram of a diffractive element and a combined aberration and information detector in accordance with another embodiment of the present invention;

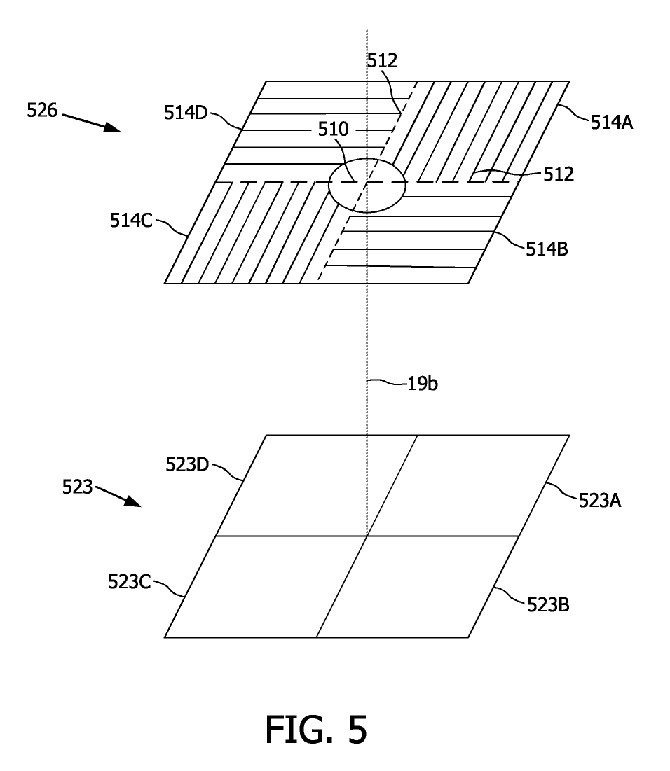

FIG. 6 is a schematic diagram of a spherical aberration detection system in accordance with another embodiment of the present invention; and

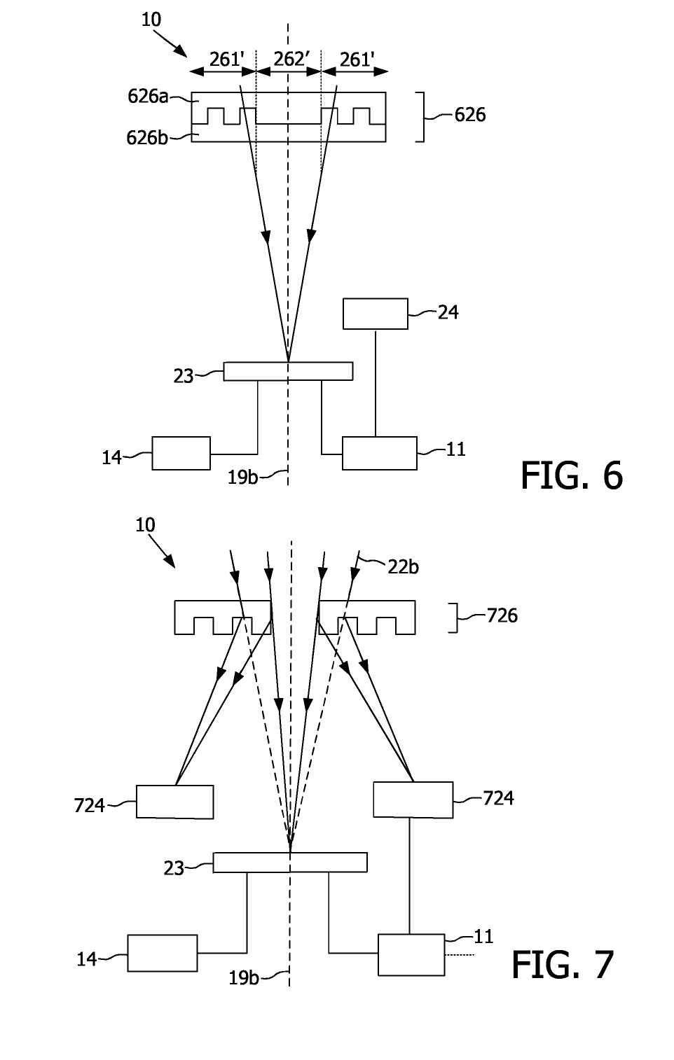

FIG. 7 is a schematic diagram of a spherical aberration detection system in accordance with a further embodiment of the present invention.

In prior art spherical aberration detection systems, such as described in U.S. Pat. No. 6,229,600, optical beams are effectively divided into two sub-beams, with each sub-beam being detected on a separate detection system. Only one of the detection systems is utilized to determine the information on the information layer of the optical record carrier.

The present inventors have realized that such a system can be undesirable, particularly in multi-wavelength optical scanning devices. Often, it is desirable to only perform active spherical aberration compensation for a particular format of optical record carrier e.g. BD. If the optical scanning device is utilized to scan other types of optical record carrier (e.g. CD and DVD), then dividing the radiation beam reflected from these optical record carriers for spherical aberration compensation is wasteful of the optical power.

The present inventors have realized that this problem can be overcome by utilizing a spherical aberration detection system incorporating a diffractive grating as described herein. The diffractive grating has steps of a predetermined size. In a first mode of operation, the steps are arranged to introduce a phase change that is substantially an integral multiple of 2π to an incident portion of radiation beam for transmitting that portion towards the information detector. In the second mode of operation, said steps are arranged to introduce a phase change that is substantially a non-integral multiple of 2π to an incident portion of the reflected first radiation beam, for diffracting that portion towards the aberration detector.

Thus, in the second mode of operation the diffractive grating acts to diffract an incident portion of the reflected first radiation beam towards the aberration detector, for detection of spherical aberration. However, in the first mode of operation, the grating acts to transmit the incident portion of the radiation beam towards the information detector. Thus, the diffractive grating is effectively invisible to the relevant incident portion of the radiation beam in the first mode, whilst in the second mode of operation, the diffractive grating structure acts to diffract the first radiation beam (e.g. the beam used for scanning BD) for spherical aberration detection. The present inventors have realized that the function of the diffractive grating structure in the first mode can be achieved by either passive means (e.g. a static diffractive grating structure) or active means (e.g. a diffractive grating structure, with at least part of the material acting to define the diffractive grating undergoing a change in configuration between modes).

An optical scanning device including such a diffractive element will now be described in more detail, and then subsequently further details of the diffractive element described.

FIG. 1 shows a device 1 for scanning a first information layer 2 of a first optical record carrier 3 by means of a first radiation beam 4, the device including an objective lens system 8.

The optical record carrier 3 comprises a transparent layer 5, on one side of which information layer 2 is arranged. The side of the information layer 2 facing away from the transparent layer 5 is protected from environmental influences by a protective layer 6. The side of the transparent layer facing the device is called the entrance face. The transparent layer 5 acts as a substrate for the optical record carrier 3 by providing mechanical support for the information layer 2. Alternatively, the transparent layer 5 may have the sole function of protecting the information layer, while the mechanical support is provided by a layer on the other side of the information layer 2, for instance by the protective layer 6 or by an additional information layer and transparent layer connected to the uppermost information layer. It is noted that the information layer has first information layer depth 27 that corresponds, in this embodiment as shown in FIG. 1, to the thickness of the transparent layer 5. The information layer 2 is a surface of the carrier 3.

Information is stored on the information layer 2 of the record carrier in the form of optically detectable marks arranged in substantially parallel, concentric or spiral tracks, not indicated in the figure. A track is a path that may be followed by the spot of a focused radiation beam. The marks may be in any optically readable form, e.g. in the form of pits, or areas with a reflection coefficient, or a direction of magnetization different from the surroundings, or a combination of these forms. In the case where the optical record carrier 3 has the shape of a disc.

As shown in FIG. 1, the optical scanning device 1 includes a radiation source 7, a collimator lens 18, a beam splitter 17, an objective lens system 8 having an optical axis 19a, a diffractive part 26, and a detection system 10. Furthermore, the optical scanning device 1 includes a servo circuit 11, a focus actuator 12, a radial actuator 13, and an information-processing unit 14 for error correction.

In this particular embodiment, the radiation source 7 is arranged for consecutively or separately supplying a first radiation beam 4, a second radiation beam 4′ and a third radiation beam 4″. For example, the radiation source 7 may comprise a tuneable semiconductor laser for consecutively supplying two of the radiation beams 4, 4′ and 4″ with a separate laser supplying the third beam, or three semiconductor lasers for separately supplying these radiation beams. The output paths of at least two of the radiation beams 4, 4′ and 4″ are different. For instance, two or more of the radiation beams may be emitted from different physical positions of the radiation source 7 and/or at different angles relative to the optical axis 19a of the objective lens system. Typically, each of the radiation beams has an optical axis that is parallel with respect to each of the other radiation beams, and emitted from different positions. For instance, the optical axes of the radiation beams may be parallel, and 100 microns apart, due to the emission points of the radiation beams from the radiation source 7 being 100 microns apart.

The radiation beam 4 has a wavelength λ₁ and a polarization p₁, the radiation beam 4′ has a wavelength λ₂ and a polarization p₂, and the radiation beam 4″ has a wavelength λ₃ and a polarization p₃. The wavelengths λ₁, λ₂, and λ₃ are all different. Preferably, the difference between any two wavelengths is equal to, or higher than, 20 nm, and more preferably 50 nm. Two or more of the polarizations p₁, p₂, and p₃ may differ from each other.

The beam splitter 17 is arranged for transmitting the radiation beams along an optical path towards the objective lens system 8. In the example shown, the radiation beams are transmitted towards the objective lens system 8 by transmission through the beam splitter 17. Preferably, the beam splitter 17 is formed with a plane parallel plate that is tilted at an angle α with respect to the optical axis, and more preferably α=45°. In this particular embodiment the optical axis 19a of the objective lens system 8 is common with an optical axis of the radiation source 7.

The collimator lens 18 is arranged on the optical axis 19a for transforming the divergent radiation beam 4 into a substantially collimated beam 20. Similarly, it transforms the radiation beams 4′ and 4″ into two respective substantially collimated beams 20′ and 20″ (not shown in FIG. 1).

The objective lens system 8 is arranged for transforming the collimated radiation beam 20 to a first focused radiation beam 15 so as to form a first scanning spot 16 in the position of the information layer 2.

During scanning, the record carrier 3 rotates on a spindle (not shown in FIG. 1), and the information layer 2 is then scanned through the transparent layer 5. The focused radiation beam 15 reflects on the information layer 2, thereby forming a reflected beam 21 which returns on the optical path of the forward converging beam 15. The objective lens system 8 transforms the reflected radiation beam 21 to a reflected collimated radiation beam 22.

The beam splitter 17 separates the forward radiation beam 20 from the reflected radiation beam 22 by transmitting at least part of the reflected radiation 22 along an optical path towards the detection system 10. In the illustrated example, the reflected radiation beam 22 is transmitted towards the detection system 10 by reflection from a plate within beam splitter 17. In the particular embodiment shown, the beam splitter 17 is a polarizing beam splitter. A quarter waveplate 9′ is positioned along the optical axis 19a between the beam splitter 17 and the objective lens system 8. The combination of the quarter waveplate 9′ and the polarizing beam splitter 17 ensures that the majority of the reflected radiation beam 22 is transmitted towards the detection system 10 along detection system optical axis 19b. The detection system optical axis 19b is a continuation of the optical axis 19a, due to the beam splitter 17 transmitting at least part of the reflected radiation 22 towards the detection system 10. Thus, the objective lens system optical axis comprises the axes indicated by reference numerals 19a and 19b.

The detection system 10 includes a convergent lens 25 and an information detector 23, which are arranged for capturing said part of the reflected radiation beam 22.

The information detector 23 is arranged to convert said part of the reflected beam to one or more electrical signals.

One of the signals is an information signal, the value of which represents the information scanned on the information layer 2. The information signal is processed by the information processing unit 14 for error correction.

Other signals from the detection system 10 are a focus error signal and a radial tracking error signal. The focus error signal represents the axial difference in height along the Z-axis between the scanning spot 16 and the position of the information layer 2. Preferably, this signal is formed by the “astigmatic method” which is known from, inter alia, the book by G. Bouwhuis, J. Braat, A. Huijiser et al, “Principles of Optical Disc Systems”, pp. 75-80 (Adam Hilger 1985, ISBN 0-85274-785-3). The radial tracking error signal represents the distance in the XY-plane of the information layer 2 between the scanning spot 16 and the center of track in the information layer 2 to be followed by the scanning spot 16. This signal can be formed from the “radial push-pull method” which is also known from the aforesaid book by G. Bouwhuis, pp. 70-73.

The servo circuit 11 is arranged for, in response to the focus and radial tracking error signals, providing servo control signals for controlling the focus actuator 12 and the radial actuator 13 respectively. The focus actuator 12 controls the position of the objective lens 8 along the Z-axis, thereby controlling the position of the scanning spot 16 such that it coincides substantially with the plane of the information layer 2. The radial actuator 13 controls the radial position of the scanning spot 16 so that it coincides substantially with the center line of the track to be followed in the information layer 2 by altering the position of the objective lens 8.

The detection system 10 further includes a spherical aberration detection system comprising an aberration detector 24 and a diffractive element 26. The spherical aberration detector is preferably in the same plane and/or a part of the information detector 23. The diffractive element is positioned along the optical axis 19b between the beam splitter 17 and the information detector 23. The diffractive element comprises two portions. A first portion of the diffractive element is arranged to transmit all incident radiation, without diffraction, towards the information detector 23. A second portion of the diffractive element consists of the diffractive grating, which comprises a series of steps of fixed, predetermined height.

In a first mode of operation the steps are arranged to transmit the incident portion of a radiation beam towards the information detector, without diffraction of that incident portion of the beam. In a second mode of operation, the steps are arranged to diffract the portion of a predetermined radiation beam towards the aberration detector 24. Spherical aberration can thus be determined, in accordance with known techniques, by comparing the signals detected at spherical aberration detector 24 and information detector 23, as for instance described within U.S. Pat. No. 6,229,600. For instance, the difference in focal position between the beam incident on information detector 23 (as transmitted through the first portion of diffractive element 26) and the beam focused on detector 24 (as diffracted by the diffractive grating of diffracting element 26) can be utilized to determine the spherical aberration of the beam in the second mode of operation. Further details of the different modes of operation will be described, with reference to specific examples of the diffractive element 26, in conjunction with the other figures.

By comparing the signals from detectors 23, 24, the servo circuit 11 can determine the appropriate degree of spherical aberration compensation required, and provide servo control signals for controlling the spherical aberration provided to the radiation beam incident on the information layer of the optical record carrier.

The objective lens 8 is arranged for transforming the collimated radiation beam 20 to the focused radiation beam 15, having a first numerical aperture NA₁, so as to form the scanning spot 16. In other words, the optical scanning device 1 is capable of scanning the first information layer 2 by means of the radiation beam 15 having the wavelength λ₁, the polarization p₁ and the numerical aperture NA₁.

Furthermore, the optical scanning device in this embodiment is also capable of scanning a second information layer 2′ of a second optical record carrier 3′ by means of the radiation beam 4′, and a third information layer 2″ of a third optical record carrier 3″ by means of the radiation beam 4″. Thus, the objective lens system 8 transforms the collimated radiation beam 20′ to a second focused radiation beam 15′, having a second numerical aperture NA₂ so as to form a second scanning spot 16′ in the position of the information layer 2′. The objective lens 8 also transforms the collimated radiation beam 20″ to a third focused radiation beam 15″, having a third numerical aperture NA₃ so as to form a third scanning spot 16″ in the position of the information layer 2″. Any one or more of the optical record carriers 3, 3′, 3″ may contain two or more information layers e.g. the record carriers can be dual layer or multi-layer. In such an instance, the objective lens system 8 is arranged to transform the collimated radiation beam 20, 20′, 20″ to a focus radiation beam 15, 15′, 15″ so as to form a scanning spot 16, 16′, 16″ on each of the information layers of the relevant optical record carrier 3, 3′, 3″.

Any one or more of the scanning spots 16, 16′, 16″ may be formed with two additional spots for use in providing an error signal. These associated additional spots can be formed by providing an appropriate diffractive element in the path of the optical beam 20.

Similarly to the optical record carrier 3, the optical record carrier 3′ includes a second transparent layer 5′ on one side of which the information layer 2′ is arranged with the second information layer depth 27′, and the optical record carrier 3″ includes a third transparent layer 5″ on one side of which the information layer 2″ is arranged with the third information layer depth 27″.

In this embodiment, the optical record carrier 3, 3′ and 3″ are, by way of example only, a “Blu-ray Disc”-format disc, a DVD-format disc and a CD-format disc, respectively. Thus, the wavelength λ₁ is comprised in the range between 365 and 445 nm, and preferably, is 405 nm. The numerical aperture NA₁ equals about 0.85 in both the reading mode and the writing mode. The wavelength λ₂ is comprised in the range between 620 and 700 nm, and preferably, is 650 nm. The numerical aperture NA₂ equals about 0.6 for a read-only drive and is above 0.6, preferably 0.65, for a drive that can both read and write data. The wavelength λ₃ is comprised in the range between 740 and 820 nm and, preferably is about 785 nm. The numerical aperture NA₃ is below 0.5, and is preferably 0.45 for a read-only drive, and preferably between 0.5 and 0.55 for a drive that can both read and write data.

FIGS. 2A and 2B show respectively first and second modes of operation of a detection system 10 including a diffractive element 26 in accordance with an embodiment of the present invention. FIG. 3 shows a plan view of the diffractive element 26, as viewed from the position of the information detector 23. It will be seen that the diffractive element 26 is circularly symmetric about optical axis 19b. The diffractive element can be regarded as being formed of two distinct portions. The first, central portion of the diffractive element 262 is arranged to transmit all the radiation beams utilized within the optical scanning device, without diffraction of any of the beams. In this particular embodiment, the first, central portion 262 is an aperture. The aperture is defined by the second peripheral portion of the grating. The second portion is an annular diffractive grating structure 261, positioned co-axial with optical axis 19b.

The annular part of the diffractive element (i.e. the diffractive grating) comprises a series of projections or steps 261a, 261b, 261c, each of predetermined, fixed height. The steps act to form a binary grating, with each step being sized so as to introduce an integer multiple (i.e. an integral multiple) of 2π phase change to a predetermined wavelength of radiation, such that all of that radiation incident on the diffractive grating is transmitted through the diffractive grating, without diffraction. For instance, the steps may be sized such that all of the radiation beam used for scanning DVDs is not diffracted by the diffractive grating. The steps will also be configured so as to diffract radiation of a first, predetermined wavelength. For instance, the grating may be utilized to select the first order diffraction in the BD radiation beam. The diffractive element may thus be formed of an annular diffractive grating structure, with the grating structure comprising substantially straight, linear zones.

FIG. 2A is a schematic diagram indicating the operation of the diffractive element in the first mode. The reflected radiation beam 22a is of the appropriate wavelength, such that the step height h of the diffractive grating 261 introduces a phase change that is an integral multiple of 2π to the portion of the radiation beam 22a incident upon the diffractive grating i.e. the diffractive grating transmits the incident portion, without diffraction, towards the information detector 23. A further portion of the radiation beam will be transmitted through the aperture 262, such that all of the radiation beam 22a incident upon the diffractive element 26 is imaged on the information detector 23, for detection of information from the information layer of the optical record carrier scanned by that radiation beam.

In FIG. 2B, a different wavelength of radiation 22b is incident upon the diffractive element 26. A central portion of the radiation beam 22b is transmitted through aperture 262, and is incident upon the information detector 23. An outer, annular portion of the radiation beam 22b is incident upon the diffractive grating portion 261, and is diffracted by the diffractive grating 261 towards the aberration detector 24. In this particular embodiment, detectors 23, 24 extend within a single, common plane.

In this particular embodiment, both the information detector 23 and the aberration detector 24 are four-quadrant detectors. Spherical aberration can hence be calculated, by comparing the two foci of the portions of the beams incident upon each detector 23, 24. Servo circuit 11 is arranged to provide appropriate servo control signals to the optical scanning device, for providing spherical aberration compensation in relation to radiation beam 22b.

Further, in the mode of operation illustrated in FIG. 2A, all of the radiation beam 22a is incident upon the information detector 23. This allows a relatively low intensity radiation beam to be provided by the initial radiation source, as none of the beam is wasted by being directed towards aberration detector 24. Thus, in that particular mode of operation, a reasonable readout speed can be maintained when scanning the optical record carrier for a given source radiation beam power.

Although the diffractive element 26 has been described as comprising a straight grating with a central hole or aperture extending through the grating, it will be appreciated that the diffractive element can alternatively comprise a diffractive grating instead of the central hole or aperture. This additional diffractive grating could be a central circular diffractive grating, or could be an inner annular diffractive grating. This additional diffractive grating would be arranged to transmit all radiation beams utilized within the optical scanning device on to the information detector 23.

Some optical systems utilize three or more radiation beams e.g. for scanning BD, DVD and CD. Typically it is desirable to perform active spherical aberration compensation for one of the radiation beams (e.g. that used to scan BD), but not for the other two readout modes (e.g. DVD and CD). Typically, the implementation of a passive solution (in which a fixed diffractive grating structure is utilized) is difficult to realize, because of the different wavelengths utilized to scan the different formats of optical record carrier.

An active solution to this problem is to utilize a switchable grating e.g. a grating structure in which the refractive index of the material adjacent/defining the diffractive grating can be switched between two or more values.

The refractive index of the material adjacent the fixed diffractive grating structure, as experienced by a polarized radiation beam passing through the diffractive grating, can be altered by use of a fluid comprising a material having two or more indices of refraction (e.g. a birefringent material). A suitable material is a liquid crystal in the nematic phase. By appropriate application of voltage, it is possible to alter the orientation (configuration) of the molecules of the liquid crystal, and hence to control the refractive index experienced by a polarized radiation beam. The phase change experienced by a radiation beam upon passing through a diffractive grating is dependent upon the wavelength of the radiation beam, and the wavelength changes as a function of refractive index. Control of the refractive index experienced by the radiation beam will this alter the phase change experienced by the radiation beam (and hence the degree, if any, of diffraction imparted by the diffractive grating to the radiation beam).

Alternatively, the refractive index can be changed by changing the material adjacent the grating steps e.g. by switching which one of two or more fluids is adjacent the fixed diffractive grating structure. A system can be provided incorporating two or more different, immiscible fluids of different refractive indices. By providing a chamber adjacent the diffractive grating, and changing which fluid is adjacent the steps of the diffractive grating, the phase change introduced by these steps to an incident radiation beam can be controllably adjusted.

FIGS. 4A and 4B show respectively a schematic cross-sectional plan view (along the line AA in FIG. 4B) and a cross sectional view (along the line BB in FIG. 4A) of a switchable grating, utilizing the electrowetting effect to switch the fluid adjacent the grating.

The diffractive element 426 is effectively formed of two portions 461, 462. Portion 461 is the central transmissive portion, which is again an aperture defined by surrounding annular portion 462.

Annular portion 462 is in turn formed of two portions: a fixed, diffractive grating 456 including steps 454, and a chamber 462 overlying the grating.

The chamber 462 is fluidly connected via two openings 442, 444 of the chamber to a conduit 441 having two opposite ends. The first opening 442 of the chamber is fluidly connected to the first end of the conduit, and the second opening 444 of the chamber is fluidly connected to the second end of the conduit, so as to form a fluid-tight enclosure for a fluid system. One side of the chamber 452 is enclosed by the diffractive grating 456, 454, which has a face (i.e. steps 454) exposed to the interior of the chamber 452. As previously, the diffractive grating is formed upon a transparent material, for example polycarbonate.

The chamber 452 is further enclosed by a cover plate 436, which is a planar element formed from a transparent material e.g. polycarbonate. The cover plate 436 is covered in a hydrophobic fluid contact layer and an electrically insulating fluid contact layer (e.g. parylene-N), which are transparent. In this embodiment, a single layer 432 is provided that is both electrically insulating and hydrophobic, and formed, for example, of Teflon™ AF1600 produced by DuPont. One surface of this hydrophobic fluid contact layer 432 is exposed to the interior of chamber 452. A first electrowetting electrode 434 is formed as a sheet of a transparent electrically conducting material, for example indium tin oxide (ITO). This first electrowetting electrode 434 has an operative area which completely overlaps with the area occupied by the area occupied by the steps 454 of the diffractive grating 456. The hydrophobic fluid contact layer 432 has a surface area which also completely overlaps the area occupied by steps 454.

The conduit 441 is formed between conduit walls 411 and a cover plate 440. The cover plate is covered by a hydrophobic fluid and electrically insulating contact layer 438 exposed on one surface to the interior of the conduit 424. A second electrowetting electrode 440 lies between the cover plate 442 and the hydrophobic fluid contact layer 438. The second electrowetting electrode 440 has a surface area which overlaps with most of the interior of the conduit 441.

The enclosed fluid system comprises a first fluid 448 and a second fluid 446. The first fluid 448 comprises an electrically susceptible fluid e.g. an electrically conductive fluid, such as salted water. The second fluid comprises an electrically unsusceptible fluid e.g. an electrically insulative fluid such as an oil. Both the first and second fluids 448, 446, have different indices of refraction and are immiscible. The first fluid 448 and the second fluid 446 lie in contact with each other at two fluid menisci 412, 414. A common, third electrode 450 is located in the conduit 441 near to one opening 444 of the chamber.

The diffractive element 426 is switchable between two discrete states. In the first discrete state, as illustrated in FIGS. 4A and 4B, fluid 448 occupies the chamber, and fluid 446 occupies the adjacent conduit. In the second discrete state, fluid 446 occupies the chamber, and fluid 448 occupies the fluid conduit. The first, second and third electrodes 434, 440, 450 form a configuration of electrowetting electrodes which, together with a voltage control system (not shown) form a fluid system switch. This switch acts upon the described fluid system, to switch between the described first and second discrete states of the switchable grating element 426. In the first discrete state, a voltage V₁ of appropriate value is applied across the first electrowetting electrode and the common third electrode. The applied voltage provides an electrowetting force such that the electrically susceptible fluid used to substantially fill the chamber. As a result of the applied voltage V₁, the hydrophobic fluid contact layer 432 of the chamber temporarily becomes effectively at least relatively hydrophilic in nature, thus manipulating the preference of the first fluid to substantially fill chamber 20.

By way of contrast, in the second discrete state, a voltage V₂ of an appropriate value is applied across the second electrowetting electrode and the common, third electrode. The voltage difference between the first and third electrode is set to zero volts. As a result of the applied voltage V₂, the hydrophobic fluid contact layer 438 of the conduit becomes temporarily effectively relatively hydrophilic in nature, thus manipulating the preference of the first fluid to substantially fill the conduit i.e. for the second fluid to fill the chamber. The element can be switched between these states by switching of the voltages, thus causing the fluids to flow between the two different positions.

In the above embodiment, a first electrowetting electrode 434 (which has an operative area which overlaps with the area occupied by the diffractive grating 456) is described as being a sheet. However, an alternative fluid-switching system can be obtained by covering the grating element with a further electrode and a hydrophobic insulating layer. This additional electrode may be utilized instead of, or in combination with, electrode 434. Providing such an additional electrode, that covers the grating element, facilitates the removal of a thin oil film that can otherwise remain trapped within the grating protrusions. Oil remaining trapped within the protrusions may disturb the optical quality of the diffractive element, particularly if oil builds up in the corners of the protrusions of the grating element.

Although this particular embodiment is described with reference to an electrically switchable fluid system (which switches using the electrowetting effect), it will be appreciated that it is possible to move the fluids between the two discrete states by other effects. For example, two immiscible fluids can be provided, each having a different index of refraction. In the first discrete state, the first fluid will cover the diffractive element. In the second discrete state, the second fluid will cover the diffractive element. The fluids are switched between the two discrete states utilizing pumping (e.g. a conventional pump). Utilizing the electrowetting effect is preferable, compared to conventional pumping, as it decreases the likelihood of an undesirable film of one fluid remaining (e.g. trapped within the corners formed by the protrusions of the diffraction grating).

The three different desired modes of operation of the spherical aberration detection system can be achieved by these two discrete states of the diffractive element 426.

For example, in the first discrete state, the refractive index of the fluid 448 adjacent the steps 454, in conjunction with the fixed step height h, provides a first mode of operation, in which the diffractive grating introduce a phase change that is an integral multiple of 2π to an incident portion of a radiation beam of predetermined wavelength (e.g. the radiation beam corresponding to DVD operation). As per the example shown in FIG. 2A, this results in all of the radiation beam being incident upon the information detector 23. In the second mode of operation, the grating 426 is still in the first discrete state. However, the steps of height h are arranged to introduce a phase change that is substantially a non-integral multiple of 2π to an incident portion of a radiation beam of another, different wavelength (e.g. the beam corresponding to BD operation). Thus, the diffractive grating will act to direct/diffract that portion of the beam incident upon the diffractive grating towards the aberration detector (i.e. similar to the operation of the system shown in FIG. 2B).

In the second discrete state, the diffractive element 426 provides the third mode of operation. For example, the combination of the step height h and the refractive index of the second fluid 446 adjacent the steps is such as to introduce a phase change that is substantially an integral multiple of 2π to a third, different radiation beam (e.g. the radiation beam corresponding to the CD mode of operation). In the simplest case, the refractive index of the fluid 446 is the same as the refractive index of the material defining the steps 454 i.e. the phase change is zero.

In an alternative embodiment, the switchable grating can be arranged to adjust the spot size for CD operation. For example, the diffractive element could be formed of two diffractive gratings, separated from one another along optical axis 19b. For example, a fluid chamber could be formed, with the first diffractive grating on a first interior surface of the chamber, and the second diffractive grating on a second, facing interior surface of the chamber. The diffractive element could be of a similar structure to that illustrated in FIGS. 4A and 4B, but with a second grating (instead of cover plate 436) facing diffractive grating 456, 454. Alternatively, a diffractive grating element could be formed of two diffractive grating structures generally as described in relation to FIGS. 4A and 4B.

Changing the fluid within the chamber(s) will thus change the mode of operation of the gratings. This can be utilized to reduce the size of the spot on the detector, by utilizing the gratings to provide a “zoom” function i.e. to increase or decrease the spot size, for any one or more incident beams of radiation. For example, the two grating structures can be arranged such that different radiation beams experience different zoom functions, so as to provide the desired size of spot incident upon each of the detector(s) for each mode of operation (incident beam of radiation). Thus, the spot size can be adjusted by utilizing the magnification provided by the two diffractive elements, so as to enlarge the radiation spot diameter incident upon each of the radiation detector(s). This can be used to compensate for the effects of stray light, and thus increase the scanning performance of the scanning device.

In yet a further embodiment of the present invention, a switchable grating is used to negate the need for utilizing a second, separate aberration detector. Instead, the information detector is utilized to function as both an information detector and an aberration detector. Thus, within one read out mode (e.g. BD operation), the detection system 10 can switch between being a focus error detector and spherical aberration detector. This allows one simple four-quadrant detector (which is already required for focusing and tracking) to be temporarily utilized as a spherical aberration detector, leading to significant cost and size reduction of the overall optical scanning device. For instance, spherical aberration need only be detected prior to starting reading or writing of a new layer in a dual layer BD. The same setting for spherical aberration compensation is maintained, until the optical scanning device changes the layer of the optical record carrier that is being scanned.

FIG. 5 illustrates one example of a suitable switchable diffractive element 526, with a corresponding information detector 523 (that is also utilized as a aberration detector). The diffractive element 526 comprises a central, transmissive portion 510. The grating defining the transmissive portion 510 is split into four discrete areas or quadrants 514A-514D. Dotted lines 512 indicate the lines of division of the different areas.

Information detector 523 is split into four, separate detection areas or quadrants 523A-523B.

The switchable grating 526 is generally the same as that illustrated with respect to FIGS. 4A and 4B, but with the diffractive grating steps 454 split into four, discrete areas. Each discrete area is arranged to diffract incident radiation differently.

In a first discrete state, the diffractive grating is arranged so as to introduce a phase change that is substantially an integral multiple of 2π to an incident portion of the relevant radiation e.g. the radiation used to scan a BD optical record carrier. Thus, the grating is effectively invisible to the incident radiation beam. Hence radiation incident upon area 514A is transmitted without diffraction, so as to be incident upon corresponding area 523A of the radiation detector, radiation incident upon segment 514B transmitted to be incident upon 523B, radiation incident upon area 514C upon 523C, and radiation incident upon area 514D upon 523D of the radiation detector.

In the second, discrete mode of operation, the refractive index of the material adjacent the steps of the diffractive portions is altered. Radiation incident upon each different area, segment or portion 514A-514D, will experience a different degree of diffraction. The diffractive part of each area is arranged to diffract the incident radiation on to a different area of the information detector. For instance, in the diffracting states, the radiation incident upon segment 514A is diffracted on to 523B, radiation incident upon 514B on to segment 523C, radiation incident upon 514C on to 523D, and radiation incident upon 514D on to 523A.

In both discrete states, the inner part of the radiation beam is not diffracted, and hence is transmitted so as to be incident on segments 523A-523D of the four-quadrant detector.

By comparing the differences in signals between the two different states, for the same radiation beam, the spherical aberration can be calculated. For instance, assuming the signals are A, B, C, D from respectively detector quadrants 523A, 523B, 523C, 523D, then it will be appreciated that signal A+C−B−D acts as the focus error signal in the non-diffracting first state, and as the spherical aberration signal in the diffracting second state.

It will be appreciated that the above embodiments are provided by way of example only, and that various alternatives will be apparent to the skilled person. For instance, the above embodiments have indicated that the central transmissive portion of the diffractive element is an aperture. However, as indicated in FIG. 6, the central, transmissive portion 262′ could be provided by a transmissive element that is arranged not to diffract incident radiation. For instance, the transmissive portion could be defined by one or more transparent elements, presenting planar surfaces to incident radiation beams, such that the radiation beams are not diffracted by the central portion. In the diffractive element 626 illustrated, the diffractive element is formed of two materials of different refractive indices 626a, 626b.

Although the preferred embodiments incorporate a diffractive grating comprising a series of steps, it will be appreciated that other embodiments of the invention may be realized by other types of diffractive grating. For instance, a sawtooth grating could be utilized. For example, different diffracted orders of incident radiation could be directed to different detectors e.g. the +1 order could be directed towards the aberration detector, and the −1 order could be directed towards the information detector.

Equally, it is not necessary that the present invention be implemented by a single spherical aberration detector, comprising a plurality of different detector elements. The diffractive element can be split into different portions, with each portion arranged to direct incident radiation to a respective spherical aberration detector. In an embodiment illustrated in FIG. 7, the diffractive element 726 is arranged, in the illustrated second mode of operation, to direct incident radiation to two, separate different detectors 724.

1. An optical scanning device (1) for scanning at least one information layer (2) of at least one optical record carrier (3), the device comprising:
a radiation source (7) for providing at least a first radiation beam (4) comprising a first wavelength;
an objective lens system (8) for converging the first radiation beam on a respective information layer (2);
an information detector (23; 523) for detecting at least a portion of the first radiation beam (22) reflected from the respective information layer, for determining information on said layer; and
a spherical aberration detection system comprising:
an aberration detector (24; 523; 724) for detecting at least a portion of the reflected first radiation beam for determining spherical aberration of the first radiation beam; and
a diffractive element (26; 426; 526; 626; 726) for diffracting at least a portion of the reflected first radiation beam towards the aberration detector (24; 523; 724), and for transmitting at least a portion of the reflected first radiation beam towards the information detector (23; 523),
wherein the diffractive element (26; 426; 526; 626; 726) comprises a diffractive grating (261; 462; 514 A-D; 261′), in a first mode of operation said grating being arranged to introduce a phase change to an incident portion of a radiation beam for transmitting that portion towards the information detector (23; 523), and in a second mode of operation said grating being arranged to introduce a phase change to an incident portion of the reflected first radiation beam for diffracting that portion towards the aberration detector (24; 523; 724).

2. A device as claimed in claim 1, wherein the diffractive grating (261; 462; 514 A-D; 261′) comprises a series of steps (261a-c; 454) of predetermined height (h), in the first mode of operation the steps being arranged to introduce a phase change that is substantially an integral multiple of 2π to said incident portion of a radiation beam for transmitting that portion towards the information detector (23; 523), and in the second mode of operation the steps being arranged to introduce a phase change that is substantially a non-integral multiple of 2π to the incident portion of the reflected first radiation beam for diffracting that portion towards the aberration detector (24; 523; 724).

3. A device as claimed in claim 1, further comprising:
a beam splitter (17) for directing incident radiation beams received from the radiation source towards the optical record carrier (3), and for directing reflected radiation beams received from the optical record carrier (3) along an optical path towards the information detector (23);
wherein the diffractive element (26) is positioned in the optical path between the beam splitter (17) and the information detector (23).

4. A device as claimed in claim 1, wherein the diffractive element (26) comprises a central portion (262; 461; 510; 262′) for transmitting incident radiation, with the diffractive grating (261; 462; 514 A-D; 261′) extending in an annulus around the central portion.

5. A device as claimed in claim 1, wherein said central portion (262; 461; 510; 262′) is an aperture defined by the annulus, the aperture extending through the diffractive element.

6. A device as claimed in claim 2, wherein said radiation source (7) is arranged for providing a second radiation beam comprising a second wavelength, the steps (261a-c; 454) of the diffractive grating being arranged in said first mode of operation to introduce a phase change that is substantially an integral multiple of 2π to the portion of the second radiation beam incident on the diffractive grating, for transmitting that portion towards the information detector.

7. A device as claimed in claim 6,
wherein said radiation source (7) is arranged for providing a third radiation beam comprising a third wavelength; and
wherein in a third mode of operation the steps (261a-c; 454) of the diffractive grating are arranged to introduce a phase change that is substantially an integral multiple of 2π to the incident portion of the third radiation beam for transmitting that portion towards the information detector.

8. A device as claimed in claim 2, wherein in the first mode of operation said steps (261a-c; 454) of the diffractive grating are arranged to introduce a phase change that is substantially an integral multiple of 2π to the incident portion of the reflected first radiation beam for transmitting that portion towards the information detector.

9. A device as claimed in claim 8, wherein the information detector (523) comprises the aberration detector, the information detector comprising a plurality of detector elements (523A-D), each arranged to detect the intensity of incident radiation;
the diffractive grating (526) being formed in a plurality of segments (514A-D), each segment comprising a respective series of said steps of predetermined height, the steps being orientated such that in said second mode of operation, the steps of each segment (514A-D) are arranged to introduce a phase change to diffract radiation incident upon the segment to a different detector element (523A-D) than the segment transmits incident radiation to when in said first mode of operation.

10. A device as claimed in claim 1, wherein the diffractive element (26; 426; 526; 626; 726) comprises at least one fluid (448, 446) and a controller (434, 440, 450) for altering the configuration of said fluid to switch said element between at least two modes of operation.

11. A device as claimed in claim 10, wherein said fluid comprises a birefringent material, and the controller is arranged to alter the orientation of the preferential axis of the birefringent material adjacent to the steps of the diffractive grating.

12. A device as claimed in claim 11, wherein said birefringent material comprises a liquid crystal, and the controller is arranged provide an electric field across the liquid crystal for altering the orientation of the liquid crystal.

13. A device as claimed in claim 10, wherein said at least one fluid (448, 446) comprises a first fluid (448) having a first refractive index, and a second fluid (446) having a second, different refractive index, the two fluids being non-miscible, the controller (434, 440, 450) being arranged to control which of said fluids is adjacent the steps (454) of the diffractive grating.

14. A device as claimed in claim 10, wherein said at least one fluid (448, 446) comprises a first fluid (448) having a first refractive index, and a second fluid (446) having a second, different refractive index, the two fluids being non-miscible, the device further comprising an electrode (434) covering at least one of the diffractive grating (456) and a cover plate (436) facing the grating, for altering the effective hydrophobicity of the grating (456) or cover plate (436) by means of a voltage difference applied between one of the fluids and said electrode.

15. A spherical aberration detection system for an optical scanning device (1) for scanning at least one information layer (2) of at least one optical record carrier (3), the device comprising: a radiation source (7) for providing at least a first radiation beam (4) comprising a first wavelength; an objective lens system (8) for converging the first radiation beam on a respective information layer (2); and an information detector (23; 523) for detecting at least a portion of the first radiation beam (22) reflected from the respective information layer, for determining information on said layer (2);
the spherical aberration detection system comprising:
an aberration detector (24; 523; 724) for detecting at least a portion of the reflected first radiation beam for determining spherical aberration of the first radiation beam; and
a diffractive element (26; 426; 526; 626; 726) for diffracting at least a portion of the reflected first radiation beam towards the aberration detector (24; 523; 724), and for transmitting at least a portion of the reflected first radiation beam towards the information detector (23; 523),
wherein the diffractive element (26; 426; 526; 626; 726) comprises a diffractive grating (261; 462; 514A-D; 261′), in a first mode of operation said grating being arranged to introduce a phase change to an incident portion of a radiation beam for transmitting that portion towards the information detector (23; 523), and in a second mode of operation said grating being arranged to introduce a phase change to an incident portion of the reflected first radiation beam for diffracting that portion towards the aberration detector (24; 523; 724).

16. A method of manufacture of an optical scanning device (1) for scanning at least one information layer (2) of at least one optical record carrier (3), the method comprising:
providing a radiation source (7) for providing at least a first radiation beam (4) comprising a first wavelength;
providing an objective lens system (8) for converging the first radiation beam on a respective information layer (2);
providing an information detector (23; 523) for detecting at least a portion of the first radiation beam (22) reflected from the respective information layer, for determining information on said layer (2); and
providing a spherical aberration detection system comprising:
an aberration detector (24; 523; 724) for detecting at least a portion of the reflected first radiation beam, for determining spherical aberration of the first radiation beam; and
a diffractive element (26; 426; 526; 626; 726) for diffracting at least a portion of the reflected first radiation beam towards the aberration detector (24; 523; 724), and for transmitting at least a portion of the reflected first radiation beam towards the information detector (23; 523),
wherein the diffractive element (26; 426; 526; 626; 726) comprises a diffractive grating (261; 462; 514A-D; 261′), in a first mode of operation said grating being arranged to introduce a phase change to an incident portion of a radiation beam for transmitting that portion towards the information detector (23; 523), and in a second mode of operation said grating being arranged to introduce a phase change to an incident portion of the reflected first radiation beam for diffracting that portion towards the aberration detector (24; 523; 724).

17. A method of operation of an optical scanning device (1) for scanning at least one information layer (2) of at least one optical record carrier (3), the device comprising:
a radiation source (7) for providing at least a first radiation beam (4) comprising a first wavelength;
an objective lens system (8) for converging the first radiation beam on a respective information layer (2);
an information detector (23; 523) for detecting at least a portion of the first radiation beam (22) reflected from the respective information layer, for determining information on said layer (2); and
a spherical aberration detection system comprising:
an aberration detector (24; 523; 724) for detecting at least a portion of the reflected first radiation beam for determining spherical aberration of the first radiation beam; and
a diffractive element (26; 426; 526; 626; 726) for diffracting at least a portion of the reflected first radiation beam towards the aberration detector (24; 523; 724), and for transmitting at least a portion of the reflected first radiation beam towards the information detector (23; 523),
wherein the diffractive element (26; 426; 526; 626; 726) comprises a diffractive grating (261; 462; 514A-D; 261′), in a first mode of operation said grating being arranged to introduce a phase change to an incident portion of a radiation beam for transmitting that portion towards the information detector (23; 523), and in a second mode of operation said grating being arranged to introduce a phase change to an incident portion of the reflected first radiation beam for diffracting that portion towards the aberration detector (24; 523; 724),
the method comprising providing the first radiation beam (4) comprising a first wavelength for scanning of an information layer (2) of an optical record carrier (3).
